(19) United States
(12) Patent Application Publication
(10) Pub. No.: US 2026/0070393 A1
(43) Pub. Date: Mar. 12, 2026

(54) HEAT PUMP SYSTEM AND CONTROL METHOD

(71) Applicant: HONDA MOTOR CO., LTD., Tokyo (JP)

(72) Inventors: Atsuro KINBARA, Tokyo (JP); Yoshiyuki TAKEUCHI, Tokyo (JP); Atsushi KOJIMA, Tokyo (JP); Eijiro NISHIMURA, Saitama (JP)

(21) Appl. No.: 19/321,611

(22) Filed: Sep. 8, 2025

(30) Foreign Application Priority Data
Sep. 11, 2024 (JP) 2024-157208
Nov. 6, 2024 (JP) 2024-194439

(51) Int. Cl. B60H 1/14; B60H 1/00; F25B 30/02; F25B 41/20; F25B 49/02

(52) U.S. Cl. CPC B60H 1/143; B60H 1/00278; B60H 1/00899; F25B 30/02; F25B 41/20; F25B 49/02; B60H 2001/00307

(57) ABSTRACT

A heat pump system is configured to be able to switch between a plurality of modes including a first heating mode that heats a passenger compartment without using waste heat of a predetermined cooling target, and a second heating mode of heating the passenger compartment using the waste heat. The controller of the heat pump system controls so that a heat transfer medium circulates by passing through a chiller, by controlling the aperture of a second throttle valve to an aperture larger than zero, during the second heating mode. On the other hand, it switches so that the heat transfer medium circulates without passing through the chiller, by decreasing the aperture of the second throttle valve until becoming zero in a state fully opening a predetermined shutoff valve, at a first switching time at which to switch from the second heating mode to the first heating mode.

This application is based on and claims the benefit of priority from Japanese Patent Application Nos. 2024-157208 and 2024-194439, respectively filed on 11 Sep. 2024 and 6 Nov. 2024, the contents of which are incorporated herein by reference.

### BACKGROUND OF THE INVENTION

### Field of the Invention

The present invention relates to a heat pump system capable of heating a passenger compartment of a moving body such as an electric vehicle.

### Related Art

In recent years, from the viewpoint of reducing the emissions of carbon dioxide to reduce the adverse effects on the world environment, etc., electric vehicles such as EVs and HEVs are becoming popular. Among these electric vehicles, etc., some are equipped with a heat pump system for heating the passenger compartment using the waste heat upon cooling a battery or the like. According to this heat pump system, it is possible to decrease the consumed energy by heating the passenger compartment by using this waste heat, and thus further reduce the adverse effect on the world environment.
Patent Document 1: Japanese Unexamined Patent Application, Publication No. 2019-219122

### SUMMARY OF THE INVENTION

Among such heat pump systems, some are configured as follows, for example. More specifically, the heat pump system is configured to be able to circulate a heat transfer medium by way of a compressor, and includes a condenser, a first throttle valve and an outdoor vessel in order from the upstream side, and includes a second throttle valve and a chiller on the downstream from at least the condenser. The chiller is configured to be able to exchange heat between a heat transfer medium of a cooling system that cools a battery, etc., and the heat transfer medium of the heat pump system.

The heat pump system further includes a shutoff valve capable of changing the flow of the heat transfer medium by opening and closing. Based on the opening and closing of this shutoff valve, it switches between a predetermined first heating mode and a predetermined second heating mode. In the first heating mode, the passenger compartment of an electric vehicle is heated without the waste heat of a battery or the like being used. On the other hand, in the second heating mode, the passenger compartment is heated by this waste heat being utilized. Based on the above, in the first heating mode, the heat transfer medium circulate without passing through the chiller; whereas, in the second heating mode, the heat transfer medium circulates by passing through the chiller.

The present inventors have focused on the fact that such heat pump systems have the problems shown below. The shutoff valve switches from one of fully open and fully closed to the other all at once. Based on this, in the case of switching from the second heating mode to the first heating mode by the opening and closing of the shutoff valve in this way, the pressure differential between both sides sandwiching the second throttle valve suddenly drops, and the flow of the heat transfer medium suddenly changes, whereby a switching sound occurs.

As a countermeasure for suppressing this switching sound, the shutoff valve switching sound countermeasure control shown below has been considered. This shutoff valve switching sound countermeasure control suppresses the output of the compressor and increases the aperture of the first throttle valve in advance in the state of the second heating mode, and then switches to the first heating mode. Thereby, the pressure differential between both sides sandwiching the second throttle valve accompanying switching is suppressed from suddenly declining, and the flow of heat transfer medium is suppressed from suddenly changing, and thus the occurrence of switching sound can be suppressed. However, in this case, in addition to such shutoff valve switching sound countermeasure control becoming necessary, it wastes energy in proportion to performing such shutoff valve switching sound countermeasure control.

It should be noted that, although problems will be described giving the example of a case in which the moving body is an electric vehicle, and the cooling target is a battery, the same problem can also arise in the case of the moving body being something other than an electric vehicle, and a case of the cooling target being something other than a battery.

The present invention has been made taking account of the situation described above, and has an object of suppressing the switching sound of modes in a heat pump system by a method other than a shutoff valve switching sound countermeasure control.

The present inventors have found that it is possible to suppress a switching sound when switching this mode, by decreasing the aperture of the second throttle valve until becoming zero, rather than fully closing the shutoff valve, thereby arriving at the present invention. The present invention is the heat pump system of the below (1) to (12), as well as the control method of (13) and (14) and the control program of (15).

(1) A heat pump system is provided to a moving body, and adapted to switch between a plurality of modes including: a first heating mode of heating a passenger compartment of the moving body without using waste heat of a predetermined cooling target, and a second heating mode of heating the passenger compartment using the waste heat, the heat pump system including:
a compressor that compresses and feeds a heat transfer medium;
a condenser disposed downstream of the compressor;
a first throttle valve disposed downstream of the condenser, and adapted to regulate an aperture;
an outdoor vessel that is disposed downstream of the first throttle valve, and performs heat exchange between the heat transfer medium and outdoor air;
a second throttle valve that is disposed downstream of at least the condenser, and adapted to regulate an aperture;
a chiller disposed downstream of the second throttle valve, and for cooling the cooling target;
a predetermined shutoff valve adapted to open and close, and adapted to change flow of the heat transfer medium by opening and closing; and
a controller,
in which the controller:
controls so that the heat transfer medium circulates by passing through the chiller by controlling the aperture of the second throttle valve to an aperture larger than zero during the second heating mode; and
switches, at a first switching time of changing from the second heating mode to the first heating mode, so that the heat transfer medium circulates without passing through the chiller by decreasing the aperture of the second throttle valve until becoming zero, while fully opening the predetermined shutoff valve.

According to the present configuration, it switches from the second heating mode to the first heating mode by decreasing the aperture of the second throttle valve in a state fully opening the predetermined shutoff valve, rather than switching from the second heating mode to the first heating mode by the opening and closing of the predetermined shutoff valve. Based on this, upon this switching, the amount of heat transfer medium flowing to the second throttle valve is gradually decreased, whereby it is possible to suppress the pressure differential between both sides sandwiching the second throttle valve from sharply declining, and suppress the flow of the heat transfer medium from suddenly changing. Based on this, it is possible to suppress the switching sound of modes in the heat pump system by a method other than a shutoff valve switching sound countermeasure method.

(2) In the heat pump system as described in (1), the second throttle valve and the chiller are disposed downstream of the outdoor vessel,
the predetermined shutoff valve is a low-pressure shutoff valve as a valve disposed in a channel branched downstream of the outdoor vessel and upstream of the second throttle valve, and
the controller
fully closes the low-pressure shutoff valve and controls the aperture of the second throttle valve to an aperture larger than zero, during the second heating mode, and
fully opens the low-pressure shutoff valve, and then decreases the aperture of the second throttle valve until becoming zero, at the first switching time.

According to the present embodiment, it is possible to suppress the switching sound of modes in the heat pump system of such a configuration.

(3) In the heat pump system as described in (1), the predetermined shutoff valve is a high-pressure shutoff valve as a valve disposed in a channel branching downstream of the condenser and upstream of the first throttle valve, the second throttle valve and the chiller are disposed downstream of the high-pressure shutoff valve, and the controller
fully opens the high-pressure shutoff valve, and controls the aperture of the second throttle valve to an aperture larger than zero, during the second heating mode, and decreases the aperture of the second throttle valve until becoming zero, while fully opening the high-pressure shutoff valve, at the first switching time.

According to the present embodiment, it is possible to suppress the switching sound of modes in the heat pump system of such a configuration.

(4) In the heat pump system as described in any one of (1) to (3), the controller increases the aperture of the second throttle valve from zero while fully opening the predetermined shutoff valve, at a second switching time to change from the first heating mode to the second heating mode.

According to the present configuration, it switches from the first heating mode to the second heating mode by increasing the aperture of the second throttle valve from zero in a state fully opening the predetermined shutoff valve, rather than switching from the first heating mode to the second heating mode by the opening and closing of the predetermined shutoff valve. Based on this, upon this switching, the amount of heat transfer medium flowing to the second throttle valve is gradually increased, whereby it is possible to suppress the pressure differential between both sides sandwiching the second throttle valve from sharply increasing, and suppress the flow of the heat transfer medium from suddenly changing. Based on this, it is possible to suppress the switching sound of modes in the heat pump system not only at the first switching time, but also at the second switching time.

(5) In the heat pump system as described in any one of (1) to (4), the chiller performs heat exchange between a heat transfer medium of the heat pump system, and a heat transfer medium of a cooling system that cools the cooling target.

According to the present configuration, it is possible to use the waste heat of the cooling target in the heating of the passenger compartment by a simple mechanism, by warming the heat transfer medium of the heat pump system with the heat transfer medium of the cooling system during the second heating mode.

(6) In the heat pump system as described in any one of (1) to (5), the condenser performs heat exchange between the heat transfer medium of the heat pump system, and a heat transfer medium of a heating system that performs heating of the passenger compartment.

According to the present configuration, it is possible to use the waste heat of the cooling target in the heating of the passenger compartment by a simple mechanism, by warming the heat transfer medium of the heating system with the heat transfer medium of the heat pump system during the second heating mode.

(7) In the heat pump system as described in any one of (1) to (6), a shutoff valve switching sound countermeasure control as control that suppresses output of the compressor and increases the aperture of the first throttle valve in a state of the second heating mode, and then switches to the first heating mode is not executed at the first switching time.

According to the present configuration, it is possible to completely eliminate the waste of energy by shutoff valve switching sound countermeasure control, by not conducting this shutoff valve switching sound countermeasure control. Based on this, it is possible to further improve the energy efficiency compared to a case of simply suppressing the execution of the shutoff valve switching sound countermeasure control, for example.

(8) In the heat pump system as described in any one of (1) to (7),
the controller switches to the first heating mode prior to stagnation of the heat transfer medium occurring in the outdoor vessel in the second heating mode, and
performs a predetermined stagnation prevention control in the state of the second heating mode, thereby lengthening a period in which the stagnation does not occur even in the second heating mode, and lengthening a period of the second heating mode, compared to when not performing the stagnation prevention control,
the stagnation prevention control includes at least either one of:
a first control as a control preventing the stagnation by changing the aperture of the first throttle valve; and
a second control as control preventing the stagnation by changing the aperture of the second throttle valve.

The second heating mode has better energy efficiency of heating than the first heating mode due to using the waste heat. However, depending on the aperture of the first throttle valve and the aperture of the second throttle valve in the second heating mode, due to the decompression range and endothermic energy amount in the outdoor vessel becoming small, the evaporation temperature rises, and the heat transfer medium is unlikely to evaporate. Then, if the evaporating temperature becomes higher than outside air, evaporation of the heat transfer medium in the outdoor vessel is not completed in time, and stagnation of the heat transfer medium occurs. Based on this, it is necessary for the controller to switch to the first heating mode prior to stagnation occurring in the second heating mode.

In this regard, according to the present configuration, it is possible to lengthen the period for which stagnation does not occur even in the second heating mode, and lengthen the period of the second heating mode, by performing the stagnation prevention control in the second heating mode. This second heating mode has higher efficiency of heating compared to the first heating mode, as described above. Based on this, it is possible to improve the energy efficiency of heating of the overall heat pump system. Furthermore, due to being able to lengthen the period of the second heating mode in this way, it is possible to reduce the frequency of performing switching between the first heating mode and the second heating mode. Based on this, it is possible to ensure the durability and reliability of each valve, and possible to lower the frequency of frost formation by moisture in the outside air freezing in the outdoor vessel.

(9) A heat pump system is provided to a moving body, and adapted to switch between a plurality of modes including: a first heating mode of heating a passenger compartment of the moving body without using waste heat of a predetermined cooling target, and a second heating mode of heating the passenger compartment using the waste heat, the heat pump system including:
a compressor that compresses and feeds a heat transfer medium;
a condenser disposed downstream of the compressor;
a first throttle valve disposed downstream of the condenser, and adapted to regulate an aperture;
an outdoor vessel that is disposed downstream of the first throttle valve, and performs heat exchange between the heat transfer medium and outdoor air;
a second throttle valve that is disposed downstream of at least the condenser, and adapted to regulate an aperture;
a chiller disposed downstream of the second throttle valve, and for cooling the cooling target;
a predetermined shutoff valve adapted to open and close, and adapted to change flow of the heat transfer medium by opening and closing; and
a controller,
in which the controller:
switches to the first heating mode prior to stagnation of the heat transfer medium occurring in the outdoor vessel in the second heating mode, and
performs a predetermined stagnation prevention control in the second heating mode, thereby lengthening a period in which the stagnation does not occur even in the second heating mode, and lengthening a period of the second heating mode, compared to when not performing the stagnation prevention control, the stagnation prevent control includes at least either one of:
a first control as a control preventing the stagnation by changing the aperture of the first throttle valve; and
a second control as control preventing the stagnation by changing the aperture of the second throttle valve.

The same effects as the effects described in (8) above can be obtained according to the present configuration.

(10) In the heat pump system as described in (8) or (9), the second throttle valve and the chiller are disposed downstream of the outdoor vessel,
the predetermined shutoff valve is a low-pressure shutoff valve as a valve disposed in a channel branching downstream of the outdoor vessel and upstream of the second throttle valve, the controller fully closes the low-pressure shutoff valve and controls the aperture of the second throttle valve to an aperture larger than zero, during the second heating mode, and the first control is control for preventing the stagnation by decreasing the aperture of the first throttle valve, and the second control is control for preventing the stagnation by increasing the aperture of the second throttle valve.

According to the present configuration, the first channel including the first throttle valve and the outdoor vessel, and the second channel including the second throttle valve and the chiller are connected in series to each other during the second heating mode. In such a situation, it is possible to conduct the stagnation prevent control.

(11) In the heat pump system as described in (8) or (9), the predetermined shutoff valve is a high-pressure shutoff valve as a valve disposed in a channel branching downstream of the condenser and upstream of the first throttle valve, the second throttle valve and the chiller are disposed downstream of the high-pressure shutoff valve,
the controller fully opens the high-pressure shutoff valve, and controls the aperture of the second throttle valve to an aperture larger than zero, during the second heating mode, the first control is control for preventing the stagnation by increasing the aperture of the first throttle valve, and
the second control is control for preventing the stagnation by decreasing the aperture of the second throttle valve.

According to the present configuration, the first channel including the first throttle valve and the outdoor vessel, and the second channel including the second throttle valve and the chiller are connected in parallel to each other during the second heating mode. In such a situation, it is possible to conduct the stagnation prevent control.

(12) In the heat pump system as described in any one of (8) to (11),
the stagnation prevention control includes both of the first control and the second control.

According to the present configuration, by performing both the first control and the second control, it is possible to more securely prevent stagnation of the heat transfer medium in the outdoor vessel than a case of performing only one thereof.

(13) A control method is for a heat pump system provided to a moving body, and adapted to switch between a plurality of modes including: a first heating mode of heating a passenger compartment of the moving body without using waste heat of a predetermined cooling target, and a second heating mode of heating the passenger compartment using the waste heat, the heat pump system including:
a compressor that compresses and feeds a heat transfer medium;
a condenser disposed downstream of the compressor;
a first throttle valve disposed downstream of the condenser, and adapted to regulate an aperture;
an outdoor vessel that is disposed downstream of the first throttle valve, and performs heat exchange between the heat transfer medium and outdoor air;
a second throttle valve that is disposed downstream of at least the condenser, and adapted to regulate an aperture;
a chiller disposed downstream of the second throttle valve, and for cooling the cooling target; and
a predetermined shutoff valve adapted to open and close, and adapted to change flow of the heat transfer medium by opening and closing,
the control method including:
controlling so that the heat transfer medium circulates by passing through the chiller, by controlling the aperture of the second throttle valve to an aperture larger than zero, during the second heating mode, and
switching so that the heat transfer medium circulates without passing through the chiller, by decreasing the aperture of the second throttle valve until becoming zero, in a state fully opening the predetermined shutoff valve, at a first switching time at which to change from the second heating mode to the first heating mode.

The same effects as the system described in (1) can be obtained by the method of the present configuration.

(14) A control method is for a heat pump system provided to a moving body, and adapted to switch between a plurality of modes including: a first heating mode of heating a passenger compartment of the moving body without using waste heat of a predetermined cooling target, and a second heating mode of heating the passenger compartment using the waste heat, the heat pump system including:
a compressor that compresses and feeds a heat transfer medium;
a condenser disposed downstream of the compressor;
a first throttle valve disposed downstream of the condenser, and adapted to regulate an aperture;
an outdoor vessel that is disposed downstream of the first throttle valve, and performs heat exchange between the heat transfer medium and outdoor air;
a second throttle valve that is disposed downstream of at least the condenser, and adapted to regulate an aperture;
a chiller disposed downstream of the second throttle valve, and for cooling the cooling target; and
a predetermined shutoff valve adapted to open and close, and adapted to change flow of the heat transfer medium by opening and closing,
the control method including
switching to the first heating mode prior to stagnation of the heat transfer medium occurring in the outdoor vessel in the second heating mode, and
the control method performing a predetermined stagnation prevention control in the state of the second heating mode, thereby lengthening a period in which the stagnation does not occur even in the second heating mode, and lengthening a period of the second heating mode, compared to when not performing the stagnation prevention control,
in which the stagnation prevent control includes at least either one of:
a first control as a control preventing the stagnation by changing the aperture of the first throttle valve; and
a second control as control preventing the stagnation by changing the aperture of the second throttle valve.

The same effects as the system described in (9) can be obtained by the method of the present configuration.

(15) A control program causes a computer to function as a controller for controlling a heat pump system provided to a moving body, and adapted to switch between a plurality of modes including: a first heating mode of heating a passenger compartment of the moving body without using waste heat of a predetermined cooling target, and a second heating mode of heating the passenger compartment using the waste heat, the heat pump system including:
a compressor that compresses and feeds a heat transfer medium;
a condenser disposed downstream of the compressor;
a first throttle valve disposed downstream of the condenser, and adapted to regulate an aperture;
an outdoor vessel that is disposed downstream of the first throttle valve, and performs heat exchange between the heat transfer medium and outdoor air;
a second throttle valve that is disposed downstream of at least the condenser, and adapted to regulate an aperture;
a chiller disposed downstream of the second throttle valve, and for cooling the cooling target; and
a predetermined shutoff valve adapted to open and close, and adapted to change flow of the heat transfer medium by opening and closing,
the control program comprising causing the computer to function as:
a controller that controls so that the heat transfer medium circulates by passing through the chiller, by controlling the aperture of the second throttle valve to an aperture larger than zero, during the second heating mode, and
a controller switching so that the heat transfer medium circulates without passing through the chiller, by decreasing the aperture of the second throttle valve until becoming zero, in a state fully opening the predetermined shutoff valve, at a first switching time at which to change from the second heating mode to the first heating mode.

The same effects as the system described in (1) and the method described in (13) can be obtained by the program of the present configuration.

As described above, according to the configurations of (1), (13) and (15), it is possible to reduce the switching sound of modes by a means other than the shutoff valve switching sound countermeasure control. Furthermore, according to the configurations of (2) to (8) citing (1), additional effects can be respectively obtained. In addition, according to the configurations of (8), (9) and (14), it is possible to lengthen the period in which stagnation does not occur even in the second heating mode, and lengthen the period of the second heating mode. Furthermore, according to the configurations of (10) to (12) citing (8) and (9), additional effects can be respectively obtained.

### BRIEF DESCRIPTION OF THE DRAWINGS

FIG. 1 is a block diagram showing a heat pump system according to a first embodiment;

FIG. 2 is a block diagram showing a first cooling mode;

FIG. 3 is a block diagram showing a first heating mode;

FIG. 4 is a block diagram showing a first switching time and a second switching time;

FIG. 5 is a block diagram showing a second heating mode;

FIG. 6 is a block diagram showing a first heating mode according to a comparative embodiment;

FIG. 7 is a block diagram showing a second heating mode;

FIG. 8 is a block diagram showing a heat pump system according to a second embodiment;

FIG. 9 is a block diagram showing a first cooling mode;

FIG. 10 is a block diagram showing a first heating mode; and

FIG. 11 is a block diagram showing a second heating mode.

### DETAILED DESCRIPTION OF THE INVENTION

Hereinafter, embodiments of the present invention will be described while referencing the drawings. However, the present invention is not to be in any way limited to the following embodiments, and can be implemented by modifying where appropriate within a scope not departing from the gist of the present invention.

### First Embodiment

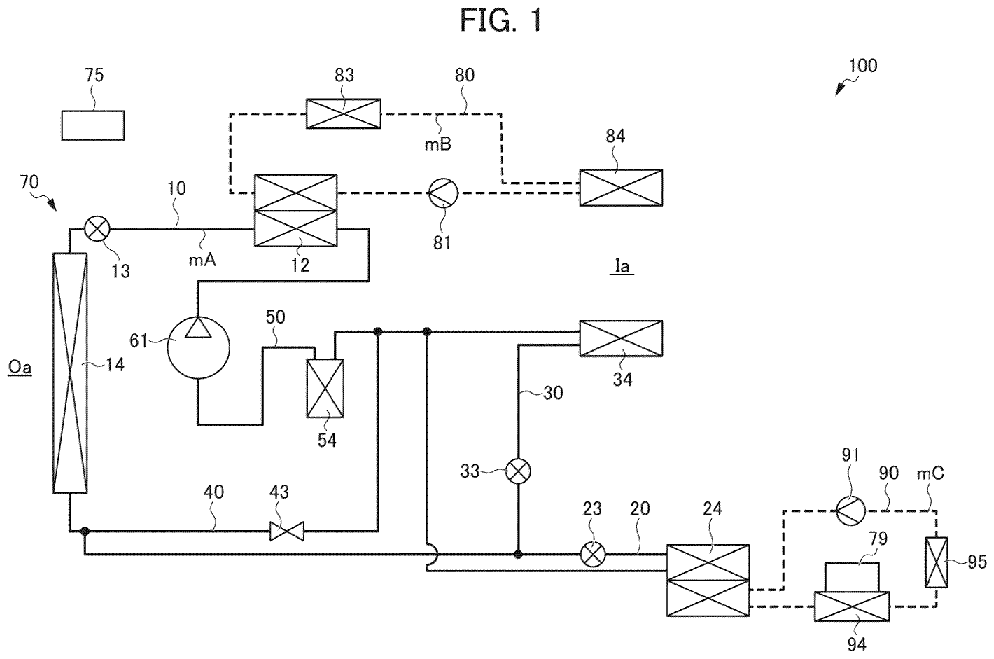

As shown in FIG. 1, a passenger compartment Ia is provided to a vehicle 100 according to the present embodiment, and a predetermined cooling target 79 is equipped thereto. This cooling target 79 may be a battery, for example, may be an IPU (Intelligent Power Unit) including a battery and a monitoring device, may be a device of a drivetrain such as a motor, may be a controller (computer including a CPU, ROM, RAM, etc.) controlling the drive train, may be the ECU (controller) of another device, or may be an engine or the like.

In addition, a heat pump system 70, a heating system 80, a cooling system 90, and a controller 75 controlling these are equipped to the vehicle 100. Hereinafter, the heat transfer medium of the heat pump system 70 is referred to as “heat transfer medium mA”, the heat transfer medium of the heating system 80 is referred to as “heat transfer medium mB”, and the heat transfer medium of the cooling system is referred to as “heat transfer medium mC”. The respective heat transfer media mA, mB, and mC may be water, a fluorocarbon refrigerant, or the like, for example, and may be a vaporizable and liquefiable substance inside the heat pump system 70 other than these.

The heating system 80 is a system for warming the air of the passenger compartment Ia, and includes an electric pump 81, a heating heater 83 and a heater core 84. The electric pump 81 feeds the heat transfer medium mB, thereby causing the heat transfer medium mB to circulate by flowing in the order of the electric pump 81->condenser 12 described later of the heat pump system 70->heating heater 83->heater core 84->electric pump 81 again.

The condenser 12 is configured to be able to exchange heat between the heat transfer medium mA and the heat transfer medium mB. The heating heater 83 is configured to be able to heat the heat transfer medium mB. The heater core 84 is configured to be able to exchange heat between the heat transfer medium mB and the air of the passenger compartment Ia.

The cooling system 90 is a system for cooling the cooling target 79, and includes an electric pump 91, a cooler 94, and a radiator 95. The electric pump 91 feeds the heat transfer medium mC, thereby causing the heat transfer medium mC to circulate by flowing in the order of the electric pump 81->chiller 24 described later of the heat pump system 70->cooler 94->radiator 95->electric pump 91 again.

The chiller 24 is configured to be able to exchange heat between the heat transfer medium mA and the heat transfer medium mC. The cooler 94 is provided at a position adjacent to the cooling target 79, and is configured to be able to exchange heat between the heat transfer medium mC and the cooling target 79. The radiator 95, for example, may be configured to be able to exchange heat between the heat transfer medium mC and radiator water, or may be configured to be able to exchange heat between the heat transfer medium mC and air.

The heat pump system 70 includes a compressor 61, and includes a first channel 10, a second channel 20, a third channel 30, a fourth channel 40 and a fifth channel 50. The upstream end of the first channel 10 is connected to an discharge port of the compressor 61. The upstream ends of the second channel 20, the third channel 30 and the fourth channel 40 are connected to the downstream end of the first channel 10. The upstream end of the fifth channel 50 is connected to the downstream ends of the second channel 20, the third channel 30 and the fourth channel 40. The downstream end of the fifth channel 50 is connected to the intake port of the compressor 61. Based on the above, the second channel 20, the third channel 30 and the fourth channel 40 are provided in parallel between the first channel 10 which is the most upstream side, and the fifth channel 50 which is the most downstream side.

The compressor 61 causes the heat transfer medium mA to circulate within the heat pump system 70 by compressing and feeding the heat transfer medium mA.

A condenser 12, a first throttle valve 13 and an outdoor vessel 14 are provided in order from the upstream side in the first channel 10. The condenser 12 is configured to be able to exchange heat between the heat transfer medium mA and the heat transfer medium mB, as described above. The first throttle valve 13 is configured to be able to regulate the aperture continuously or stepwise. The outdoor vessel 14 is configured to be able to exchange heat between the heat transfer medium mA and the air outside the vehicle Oa. It should be noted that “air outside the vehicle Oa” may be substituted with the term outside air.

A second throttle valve 23 and a chiller 24 are provided in order from the upstream side in the second channel 20. The second throttle valve 23 is configured to be able to regulate the aperture continuously or stepwise. The chiller 24 is configured to be able to exchange heat between the heat transfer medium mA and the heat transfer medium mC, as described above.

A third throttle valve 33 and an evaporator 34 are provided in order from the upstream side in the third channel 30. The third throttle valve 33 is configured to be able to regulate the aperture continuously or stepwise. The evaporator 34 is configured to be able to exchange heat between the heat transfer medium mA and the air inside of the passenger compartment Ia or aspirated outside air.

A low-pressure shutoff valve 43 is provided in the fourth channel 40. The low-pressure shutoff valve 43 is a solenoid valve or the like, and is configured to be able to alternatively switch to either one of fully open or fully closed. It should be noted that, in the present embodiment, “low-pressure shutoff valve 43” may be substituted with the term “predetermined solenoid valve”.

An accumulator 54 is provided in the fifth channel 50.

The controller 75 controls each of the systems 70, 80 and 90 shown above. It should be noted that the controller 75 may be regarded as part of each of these systems 70, 80 and 90. The controller 75 is configured mainly of a computer, and a control program causing this to function as the controller 75. In other words, the controller 75 is realized by cooperation between the computer and the control program. The computer, for example, includes a CPU, ROM, RAM, etc. The control program is stored in a computer-readable recording medium.

The controller 75 is configured to be able to alternatively switch the mode of the heat pump system 70 to any of a plurality of modes. This plurality of modes at least includes a predetermined first cooling mode cl, a predetermined first heating mode h1, and a predetermined second heating mode h2. The first cooling mode cl is a mode cooling the air of the passenger compartment Ia. The first heating mode h1 is a mode warming the heat transfer medium mB for warming the air of the passenger compartment Ia, without using the waste heat from the cooling target 79. The second heating mode h2 is a mode warming the heat transfer medium mB using waste heat of the cooling target 79.

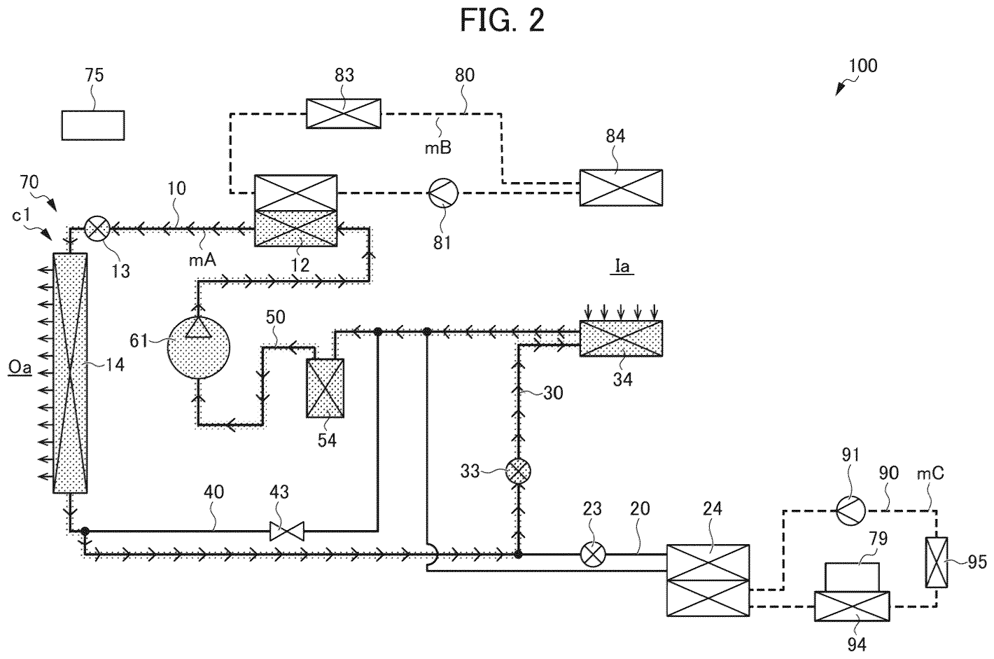

First, the first cooling mode cl will be described while referencing FIG. 2. During the first cooling mode cl, the controller 75 causes the low-pressure shutoff valve 43 and second throttle valve 23 to fully close, and controls the apertures of the first throttle valve 13 and the third throttle valve 33 to an aperture larger than zero. Thereby, the heat transfer medium mA circulates by flowing in order of the compressor 61->first channel 10->third channel 30->fifth channel 50->compressor 61 again. At this time, according to the aperture control of the first throttle valve 13 and third throttle valve 33, in the condenser 12 and outdoor vessel 14 which are on an upstream side from the third throttle valve 33, the heat transfer medium mA liquefies, and in the evaporator 34 which is on a downstream side from the third throttle valve 33, the heat transfer medium mA vaporizes.

Based on this, it liquefies in the outdoor vessel 14, and heat exchange is carried out between high-temperature heat transfer medium mA and the air outside the vehicle Oa, whereby the heat transfer medium mA is cooled. Subsequently, this liquid heat transfer medium mA vaporizes in the evaporator 34 and becomes low temperature by passing through the third throttle valve 33. By heat exchange being performed between this gaseous heat transfer medium mA and air inside the passenger compartment Ia or aspirated outside air, the air inside the passenger compartment Ia is cooled. Subsequently, this gaseous heat transfer medium mA returns to the compressor 61 through the accumulator 54.

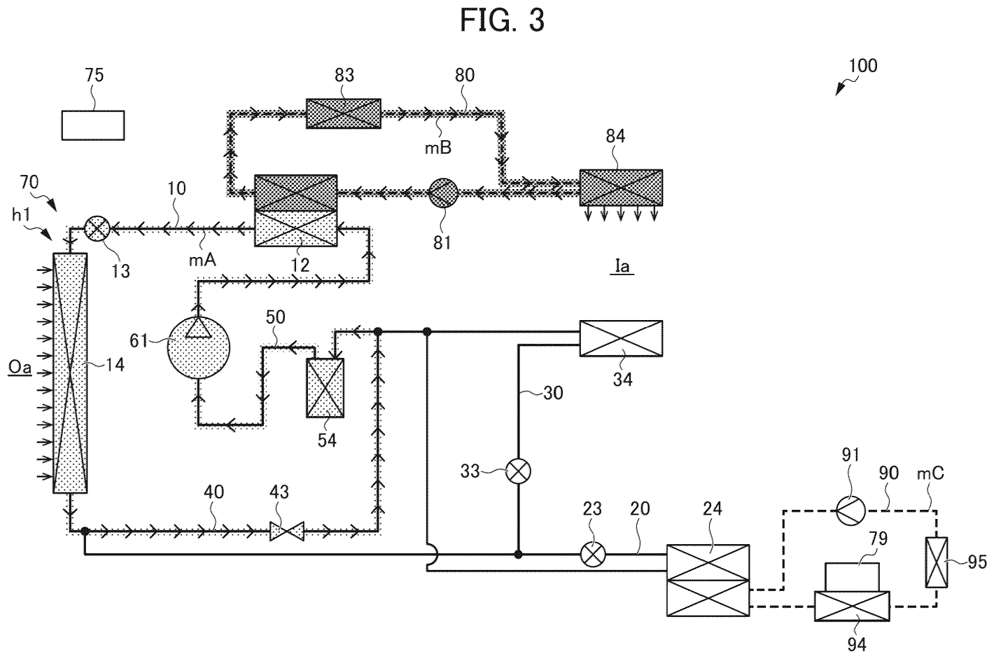

Next, the first heating mode h1 will be described while referencing FIG. 3. During the first heating mode h1, the controller 75 causes the electric pump 81 to operate and cause the heat transfer medium mB to circulate within the heating system 80.

In addition, in the heat pump system 70, the controller 75 causes the second throttle valve 23 and the third throttle valve 33 to fully close, and controls the aperture of the first throttle valve 13 to an aperture larger than zero, and fully opens the low-pressure shutoff valve 43. Thereby, the heat transfer medium mA circulates by flowing in the order of the compressor 61->first channel 10->fourth channel 40->fifth channel 50->compressor 61 again. At this time, according to the aperture control of the first throttle valve 13, while the heat transfer medium mA liquefies in the condenser 12 which is more upstream than the first throttle valve 13, the heat transfer medium mA vaporizes in the outdoor vessel 14 which is more downstream than the first throttle valve 13.

Based on this, the heat transfer medium mA flowing into the condenser 12 from the compressor 61 liquefies and becomes high temperature. Heat exchange is carried out between this liquid heat transfer medium mA and the heat transfer medium mB, and the heat transfer medium mB is warmed. The air of the passenger compartment Ia is warmed by this heat transfer medium mB. The liquid heat transfer medium mA having passed through the condenser 12 vaporizes in the outdoor vessel 14 and becomes low temperature by passing through the first throttle valve 13. By heat exchange being carried out between this gaseous heat transfer medium mA and air outside the vehicle Oa, the heat transfer medium mA is warmed. This gaseous heat transfer medium mA returns to the compressor 61 via the low-pressure shutoff valve 43 and accumulator 54 in order.

In this way, during the first heating mode h1, the heat transfer medium mA is made to circulate without going through the chiller 24. Thereby, the air of the passenger compartment Ia is warmed without using the waste heat of the cooling target 79.

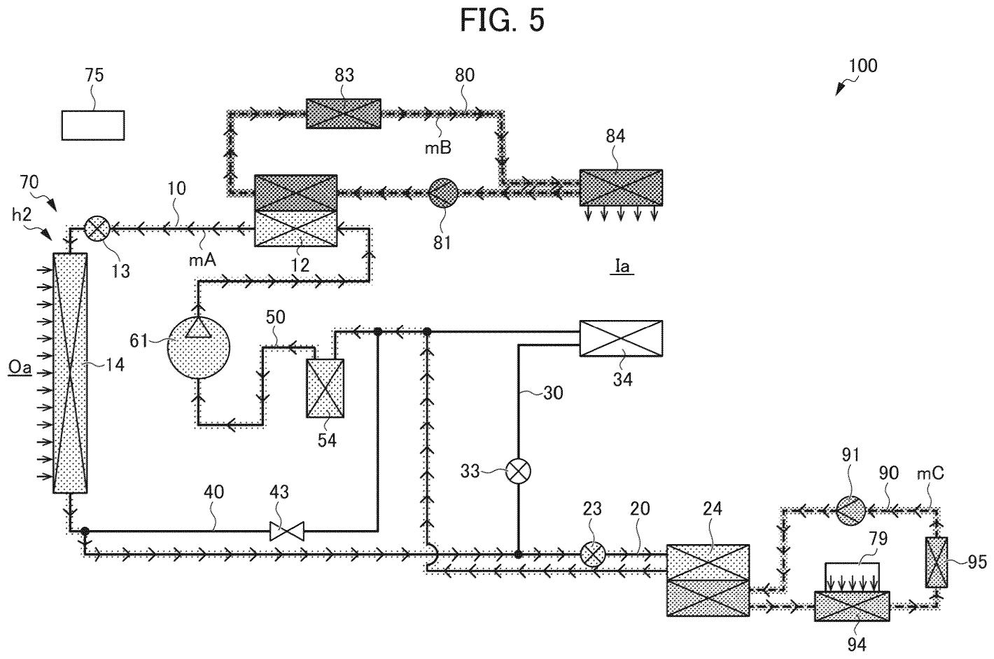

Next, the second heating mode h2 will be described while referencing FIG. 5. Also during the second heating mode h2, similarly to during the first heating mode h1, the controller 75 causes the electric pump 81 to operate to cause the heat transfer medium mB to circulate within the heating system 80. Furthermore, the controller 75 causes the electric pump 91 to operate to cause the heat transfer medium mC to circulate within the cooling system 90.

In addition, in the heat pump system 70, the controller 75 causes the third throttle valve 33 and low-pressure shutoff valve 43 to fully close, and controls the apertures of the first throttle valve 13 and second throttle valve 23 to apertures larger than zero. Thereby, the heat transfer medium mA circulates by flowing in the order of the compressor 61->first channel 10->second channel 20->fifth channel 50->compressor 61 again. At this time, according to the aperture control of the first throttle valve 13 and second throttle valve 23, while the heat transfer medium mA liquefies in the condenser 12 which is more upstream than the first throttle valve 13, the heat transfer medium mA vaporizes in the outdoor vessel 14 and the chiller 24 which are more downstream than the first throttle valve 13.

Based on this, the heat exchange h is carried out similarly to a case of the first heating mode h1, in the condenser 12 and the outdoor vessel 14. Subsequently, the gaseous heat transfer medium mA having passed through the outdoor vessel 14 passes through the second throttle valve 23 and flows into the chiller 24. In this chiller 24, by heat exchange being carried out between the heat transfer medium mA and the heat transfer medium mC, the heat transfer medium mC is cooled, and the heat transfer medium mA is warmed. The cooling target 79 is cooled by this heat transfer medium mC. The gaseous heat transfer medium mA having passed through the chiller 24 returns to the compressor 61 via the accumulator 54.

The heat transfer medium mA having returned to the compressor 61 is fed to the condenser 12 again, and heat exchange is carried out with the heat transfer medium mB. Based on this, the waste heat from the cooling target 79 is employed to warm the air of the passenger compartment Ia. In this way, during the second heating mode h2, the heat transfer medium mA is made to circulate via the chiller 24. Thereby, the air of the passenger compartment Ia is warmed using the waste heat of the cooling target 79.

Next, three problems to be solved in the present embodiment will be described.

First, a first problem will be described. Hereinafter, an event of evaporation of the heat transfer medium mA not completing in time in the outdoor vessel 14, and the heat transfer medium mA accumulating in the outdoor vessel 14 as a liquid is referred to as “stagnation of heat transfer medium mA in outdoor vessel 14” or simply “stagnation”. The energy efficiency of heating is better in the second heating mode h2 than the case of the first heating mode h1, due to using the waste heat of the cooling target 79. However, in the second heating mode h2, depending on the aperture of the first throttle valve 13 and the second throttle valve 23, the heat transfer medium mA is unlikely to evaporate in the outdoor vessel 14. More specifically, as in the present embodiment, in a situation in which the first channel 10 and the second channel 20 are connected in series during the second heating mode h2, if setting the aperture of the first throttle valve 13 too large compared to the aperture of the second throttle valve 23, due to the decompression range and endothermic energy amount in the outdoor vessel 14 becoming small, the evaporation temperature rises, and the heat transfer medium mA is unlikely to evaporate.

Then, if the evaporation temperature becomes higher than outside air, evaporation of the heat transfer medium mA in the outdoor vessel 14 is not completed in time, and stagnation of the heat transfer medium mA occurs. Based on this, the controller 75 switches to the first heating mode h1 prior to stagnation occurring in the second heating mode h2. However, it is desired to maintain the second heating mode h2 having good energy efficiency of heating as long as possible. In addition, from the viewpoint of ensuring the durability and reliability of each valve, and the viewpoint of suppressing the frequency of frost formation by moisture in the outside air freezing in the outdoor vessel 14, it is also desired to decrease the frequency of switching between the first heating mode h1 and the second heating mode h2

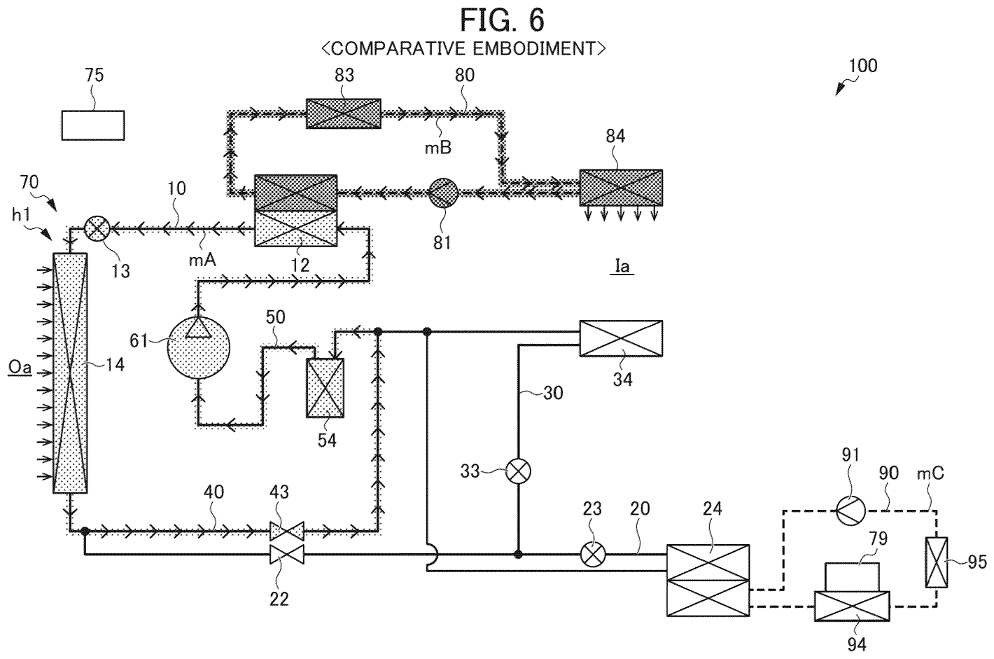

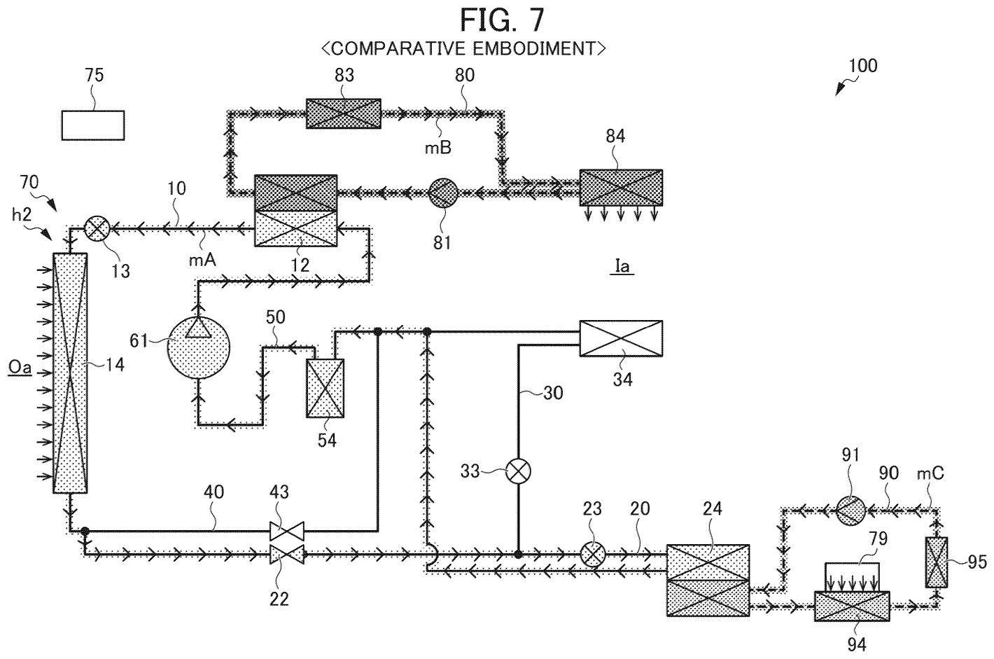

Next, a second problem will be described. Hereinafter, as shown in FIGS. 6 and 7, a configuration in which an additional shutoff valve 22 is provided between the first channel 10 and the second channel 20 is referred to as “Comparative Embodiment”. The additional shutoff valve 22 is a solenoid valve or the like, and is configured to be alternatively switchable to either one of fully open and fully closed.

In the comparative embodiment, it is assumed the second heating mode h2 shown in FIG. 7 is switched to the first heating mode h1 shown in FIG. 6, by fully opening the low-pressure shutoff valve 43 and fully closing the additional shutoff valve 22, while setting the aperture of the second throttle valve 23 to an aperture larger than zero. In this case, the following issue arises. That is, accompanying the full closing of the additional shutoff valve 22 herein, the pressure differential between both sides sandwiching the second throttle valve 23 sharply decreases, and the flow of heat transfer medium mA suddenly changes. A switching sound thereby generates.

As a countermeasure to this second problem, the shutoff valve switching sound countermeasure control shown next has been considered. In this shutoff valve switching sound countermeasure control, in the second heating mode h2 shown in FIG. 7, the revolution speed of the compressor 61 is suppressed to suppress output in advance, and the aperture of the first throttle valve 13 is made to increase. From this state, by causing the low-pressure shutoff valve 43 to fully open and causing the additional shutoff valve 22 to fully close as mentioned above, it is switched to the first heating mode h1 shown in FIG. 6. In the above shutoff valve switching sound countermeasure control, by suppressing the output of the compressor 61, it is possible to suppress the pressure differential between both sides sandwiching the second throttle valve 23 from suddenly dropping accompanying switching, and suppress the flow of the heat transfer medium mA from suddenly changing, and thus suppress the occurrence of switching sound. However, in this case, in addition to such shutoff valve switching sound countermeasure control being necessary, energy is wasted by the amount of performing such shutoff valve switching sound countermeasure control.

Next, a third problem will be described. It is assumed that it is switched from a state fully closing the additional shutoff valve 22 and setting the aperture of the second throttle valve 23 to an aperture larger than zero in the first heating mode h1 of the comparative embodiment shown in FIG. 6, to the second heating mode h2 shown in FIG. 7, by fully opening the additional shutoff valve 22 and fully closing the low-pressure shutoff valve 43. The following problem arises in this case. That is, accompanying fully opening of the additional shutoff valve 22 herein, the pressure differential between both sides sandwiching the second throttle valve 23 suddenly increases, and the flow of the heat transfer medium mA suddenly changes. A switching sound thereby arises.

The controller 75 of the present embodiment performs the following control to solve the above first to third problems. Hereinafter, when it should be switched from the second heating mode h2 to the first heating mode h1 is referred to as “first switching time v1”, and when it should be switched from the first heating mode h1 to the second heating mode h2 is referred to as “second switching time v2”.

First, in the state of the second heating mode h2 shown in FIG. 5, a predetermined stagnation prevent control is performed. Thereby, the period in which stagnation does not occur in the second heating mode h2 is lengthened, and the period of the second heating mode h2 is made as long as possible. More specifically, the timing of switching from the second heating mode h2 to the first heating mode h1 is delayed as much as possible, and the timing of switching from the first heating mode h1 to the second heating mode h2 is advanced as much as possible.

The stagnation prevention control includes first control and second control. In the first control, stagnation is prevented by decreasing the aperture of the first throttle valve 13 as necessary. On the other hand, in the second control, stagnation is prevented by increasing the aperture of the second throttle valve 23 as necessary. This decrease in the aperture of the first throttle valve 13 in the first control, and increase in the aperture of the second throttle valve 23 in the second control are performed at a minimum within a range which can prevent stagnation, i.e. within a range in which the evaporation temperature of the heat transfer medium mA does not exceed the temperature of the outside air in the outdoor vessel 14. Thereby, the aperture of the first throttle valve 13 is made as large as possible, and the aperture of the second throttle valve 23 is made as small as possible, within this range. This is because a larger aperture of the first throttle valve 13 and a smaller aperture of the second throttle valve 23 will more abundantly use the waste heat of the cooling target 79, and thus the energy efficiency of heating further improves.

On the other hand, in the case of being in the second heating mode h2, e.g., in the following case, the controller 75 switches to the first heating mode h1. Firstly, in order to prevent stagnation, in the case of being demanded to control the aperture of the second throttle valve 23 to an aperture no more than a predetermined minimum feasible aperture, it switches to the first heating mode h1. In addition, secondly, also in the case of not cooling the cooling target 79, it switches to the first heating mode h1. Furthermore, thirdly, also in the case of the evaporating temperature of the heat transfer medium mA exceeding a predetermined evaporating temperature threshold in the outdoor vessel 14 based on the heating demanded capacity, it switches to the first heating mode h1. This evaporating temperature threshold is preferably as high as possible within a range lower than the temperature of the outside air. This evaporating temperature predetermined value may be determined considering the precision of the evaporating temperature sensor, pressure sensor, etc.

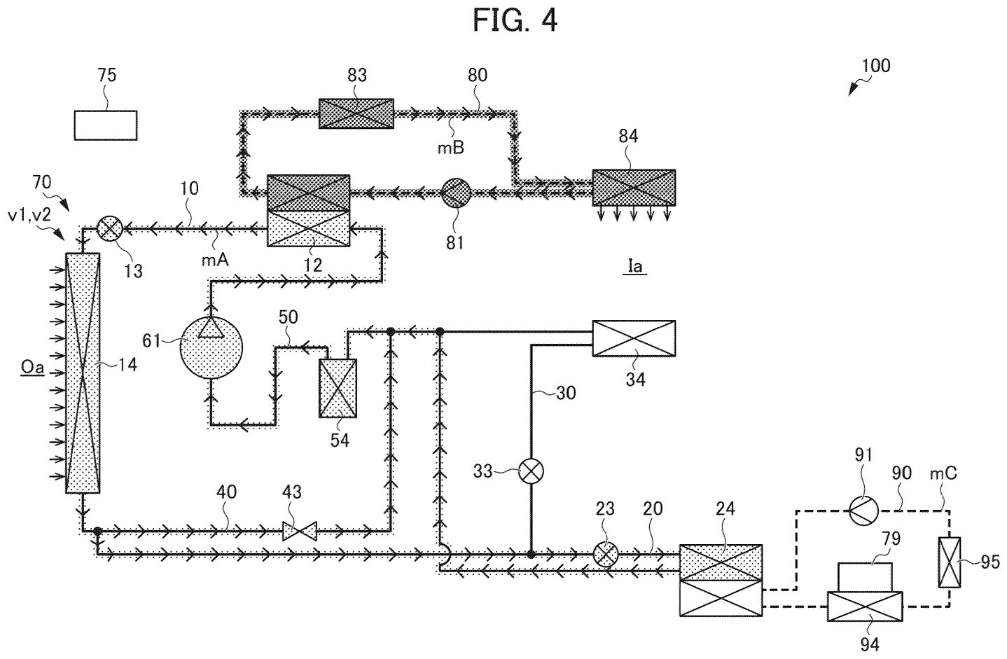

During switching from the second heating mode h2 to the first heating mode h1, i.e. first switching time v1, first the low-pressure shutoff valve 43 is fully opened as shown in FIG. 4. Thereby, the heat transfer medium mA is divided to flow from the first channel 10 to the second channel 20 and the fourth channel 40, and merges together at the fifth channel 50.

Subsequently, while fully opening the low-pressure shutoff valve 43, the aperture of the first throttle valve 13 is gradually increased, and the aperture of the second throttle valve 23 is gradually decreased until becoming zero. Then, when the aperture of the second throttle valve 23 becomes zero, as shown in FIG. 3, the heat transfer medium mA comes to flow from the first channel 10 to only the fourth channel 40 among the second channel 20 and the fourth channel 40. In other words, the heat transfer medium mA circulates by flowing in the order of the compressor 61->first channel 10->fourth channel 40->fifth channel 50->compressor 61 again, and is switched to the first heating mode h1.

It should be noted that, based on the above, in the present embodiment, the aforementioned shutoff valve switching sound countermeasure control is not carried out at the first switching time v1.

When switching from the first heating mode h1 to the second heating mode h2, i.e. at the second switching time v2, first, from the state of the first heating mode h1 shown in FIG. 3, the aperture of the second throttle valve 23 is gradually increased from zero. Thereby, as shown in FIG. 4, the heat transfer medium mA is divided to flow from the first channel 10 into the second channel 20 and the fourth channel 40, and merges together at the fifth channel 50. Subsequently, the low-pressure shutoff valve 43 is fully closed. Thereby, as shown in FIG. 5, the heat transfer medium mA comes to flow from the first channel 10 to only the second channel 20 among the second channel 20 and the fourth channel 40. In other words, the heat transfer medium mA circulates by flowing in the order of the compressor 61->first channel 10->second channel 20->fifth channel 50->compressor 61 again, and switches to the second heating mode h2.

Hereinafter, the configuration and effects of the present embodiment will be summarized.

It is necessary for the controller 75 to switch to the first heating mode h1 prior to stagnation occurring in the second heating mode h2. At this point, the controller 75 performs stagnation prevention control in the state of the second heating mode h2. Thereby, it is possible to lengthen the period in which stagnation does not occur in the second heating mode h2, and thus lengthen the period of the second heating mode h2, compared to a case of not performing this stagnation prevention control. Since this second heating mode h2 heats using the waste heat of the cooling target 79, the energy efficiency of heating is high compared to the first heating mode h1. Based on this, it is possible to improve the energy efficiency of heating of the overall heat pump system 70. Furthermore, since it is possible to lengthen the period of the second heating mode h2 in this way, it is possible to decrease the frequency of performing switching between the first heating mode h1 and the second heating mode h2. Based on this, it is possible to ensure the durability and reliability of each valve, and lower the frosting frequency. In other words, the above-mentioned first problem can be solved.

The stagnation prevent control of the present embodiment performs both the first control of preventing stagnation by decreasing the aperture of the first throttle valve 13, and the second control of preventing stagnation by increasing the aperture of the second throttle valve 23. Based on this, compared to a case of performing only one, it is possible to prevent stagnation more flexibly and firmly. However, in the case of being able to sufficiently prevent stagnation with only either one of the first control and the second control, it may be configured to perform only one.

At the first switching time v1, first, from a state of the second heating mode h2 shown in FIG. 5, the low-pressure shutoff valve 43 is fully opened to flow the heat transfer medium mA also to the fourth channel 40 in parallel with the second channel 20, as shown in FIG. 4. Subsequently, while the low-pressure shutoff valve 43 is fully opened, the aperture of the second throttle valve 23 is decreased to zero. Thereby, the flowrate of the heat transfer medium mA flowing in the second channel 20 is gradually decreased, thereby switching to the first heating mode h1 shown in FIG. 3. Based on this, it is possible to suppress the flow of the heat transfer medium mA from suddenly changing, and thus suppress switching noise, together with suppressing the pressure differential between both sides sandwiching the second throttle valve 23 from sharply declining. In other words, the above-mentioned second problem can be solved.

At the second switching time v2, from the first heating mode h1 shown in FIG. 3, by increasing the aperture of the second throttle valve 23 from zero, while the low-pressure shutoff valve 43 is fully opened, the heat transfer medium mA is gradually flowed also to the second channel 20 in parallel with the fourth channel 40, as shown in FIG. 4. Based on this, it is possible to suppress the flow of the heat transfer medium mA from suddenly changing, and thus suppress switching noise, together with suppressing the pressure differential between both sides sandwiching the second throttle valve 23 from suddenly increasing. In other words, the above-mentioned third problem can be solved. It should be noted that, by subsequently fully closing the low-pressure shutoff valve 43 as described above, it is switched to the second heating mode h2 shown in FIG. 5.

As shown in FIG. 5, the chiller 24 performs heat exchange between the heat transfer medium mA and the heat transfer medium mC. Based on this, by warming the heat transfer medium mA with the heat transfer medium mC during the second heating mode h2, it is possible to use the waste heat of the cooling target 79 with a simple mechanism.

In addition, the condenser 12 performs heat exchange between the heat transfer medium mA and the heat transfer medium mB. Based on this, by warming the heat transfer medium mB with the heat transfer medium mA during the second heating mode h2, it is possible to use the waste heat of the cooling target 79 with a simple mechanism.

At the first switching time v1 shown in the order of FIG. 5->FIG. 4->FIG. 3, the aforementioned shutoff valve switching sound countermeasure control is not carried out. Based on this, it is possible to further improve the energy efficiency compared to a case of simply suppressing the execution of the shutoff valve switching noise countermeasure control.

### Second Embodiment

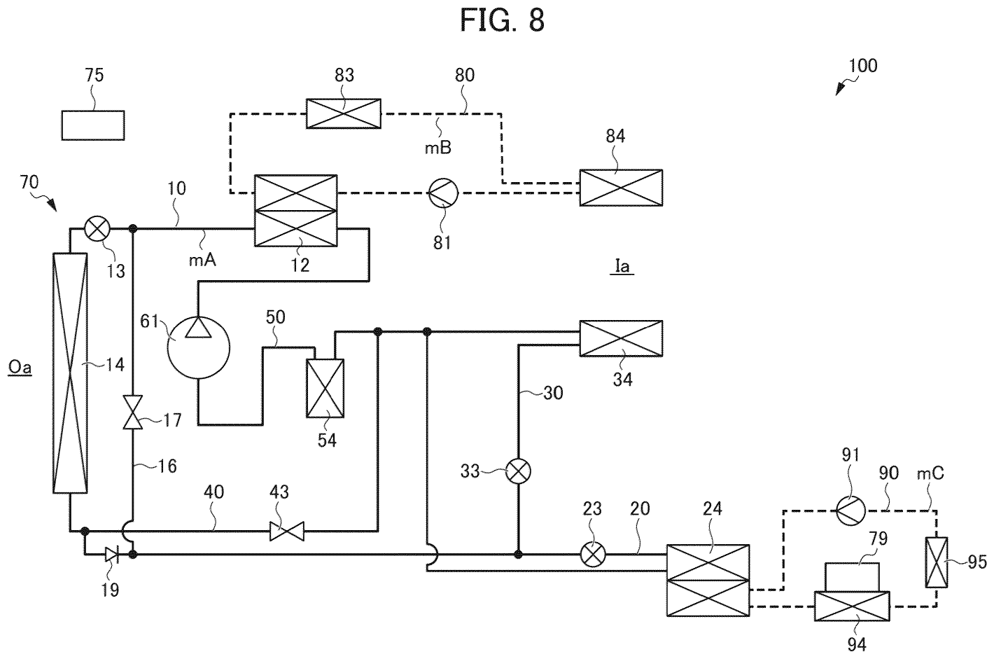

Next, a second embodiment will be described while referencing FIGS. 8 to 11. For the present embodiment, a description will be provided based on the first embodiment, focusing on the points differing from this, and descriptions will be omitted for points which are identical or similar to the first embodiment.

As shown in FIG. 8, the heat pump system 70 further includes a check valve 19 and a bypass channel 16. The check valve 19 is provided between the downstream end of the first channel 10 and the upstream end of each of the second channel 20 and the third channel 30. This check valve 19 allows the flow of the heat transfer medium mA from the upstream side to the downstream side, while preventing the flow of the heat transfer medium mA from the downstream side to the upstream side. It should be noted that the upstream end of the fourth channel 40 is connected to the downstream end of the first channel 10 without going through the check valve 19, similarly to the case of the first embodiment.

The bypass channel 16 connects a portion of the first channel 10 located downstream of the condenser 12 and upstream of the first throttle valve 13, to a portion located downstream of the check valve 19 and upstream of each of the upstream ends of the second channel 20 and the third channel 30. A high-pressure shutoff valve 17 is provided to this bypass channel 16. This high-pressure shutoff valve 17 is a solenoid valve or the like, and is configured to be alternatively switchable to either one of fully open and fully closed. It should be noted that, in the present embodiment, the term “high-pressure shutoff valve 17” can be replaced with “predetermined shutoff valve”.

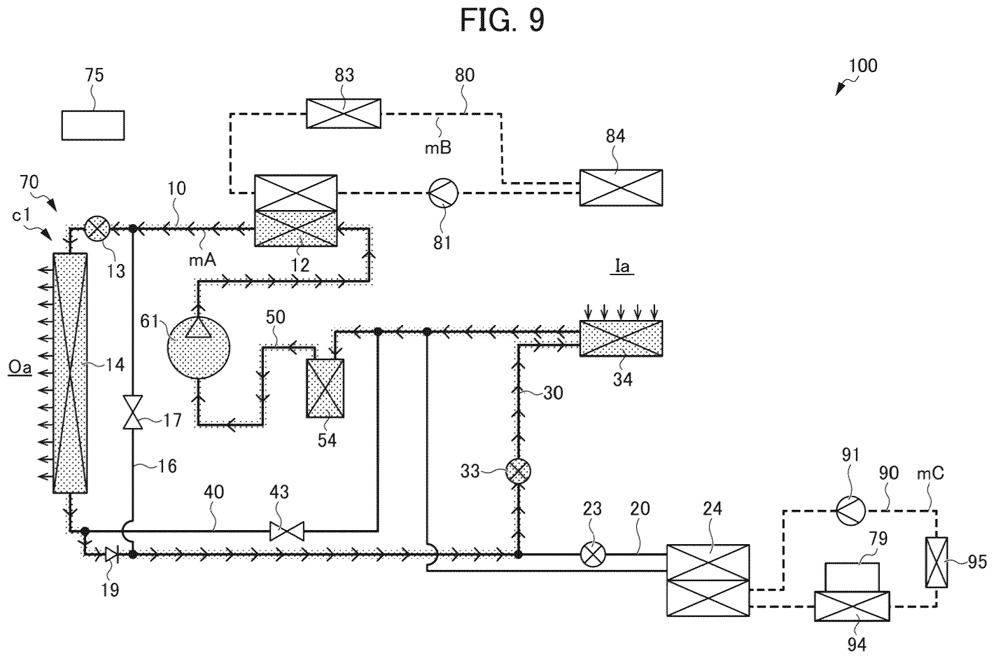

During the first cooling mode cl shown in FIG. 9, the controller 75 performs similar control to the case of the first embodiment, while fully closing the high-pressure shutoff valve 17.

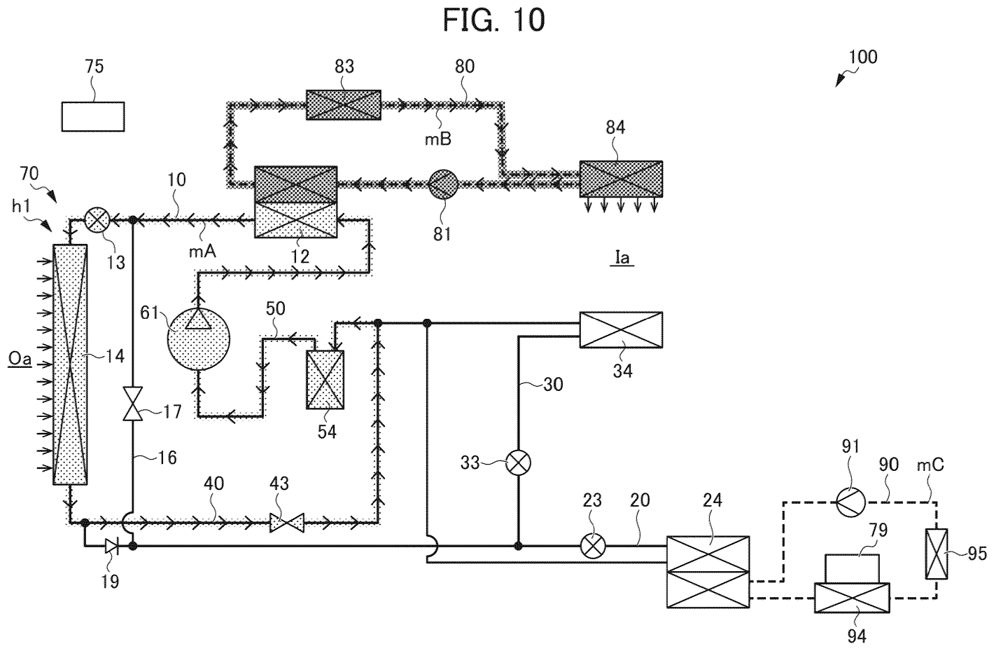

During the first heating mode h1 shown in FIG. 10, the controller 75 fully closes the high-pressure shutoff valve 17. Other than this, control similar to the case of the first embodiment is performed. In other words, the second throttle valve 23 and the third throttle valve 33 fully close, the aperture of the first throttle valve 13 is controlled to an aperture larger than zero, and the low-pressure shutoff valve 43 is fully opened. Thereby, the heat transfer medium mA circulates by flowing in the order of the compressor 61->first channel 10->fourth channel 40->fifth channel 50->compressor 61 again.

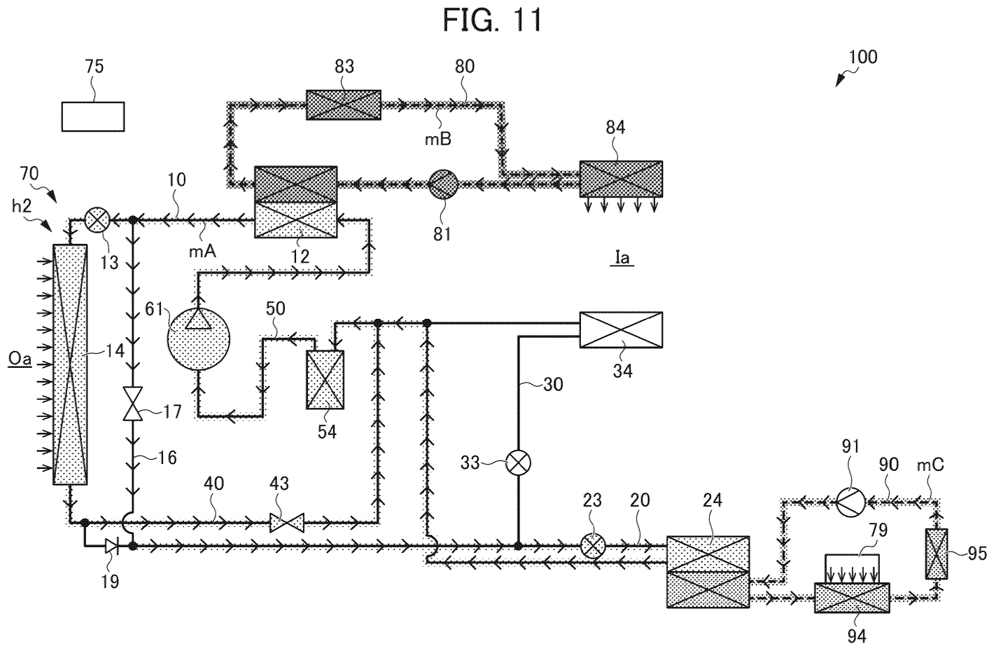

During the second heating mode h2 shown in FIG. 11, the controller 75 causes the high-pressure shutoff valve 17 and the second throttle valve to fully open, while controlling the first throttle valve 13 and the second throttle valve 23 to apertures larger than zero. Thereby, the heat transfer medium mA circulates by flowing in the order of the compressor 61->first channel 10->fourth channel 40->fifth channel 50->compressor 61 again, and also flowing to a channel branching to the bypass channel 16 in the middle of the first channel 10 to pass through the second channel 20, and then merging together at the fifth channel 50. At this time, according to the aperture control of the first throttle valve 13 and the second throttle valve 23, the heat transfer medium mA liquefies at the condenser 12 which is upstream from the first throttle valve 13 and the second throttle valve 23. On the other hand, the heat transfer medium mA vaporizes at the outdoor vessel 14 which is downstream from the first throttle valve 13, and the chiller 24 which is downstream from the second throttle valve 23.

Also in the present embodiment, during this second heating mode h2, the period of the second heating mode h2 is made as long as possible, by performing the stagnation prevention control. However, in the present embodiment, during this second heating mode h2, the first channel 10 and the second channel 20 are connected in parallel rather than in series. Based on this, the first control and the second control of the stagnation prevention control according to the present embodiment are opposite to the case of the first embodiment. In other words, the first control prevents stagnation by increasing the aperture of the first throttle valve 13 as necessary. On the other hand, the second control prevents stagnation by decreasing the aperture of the second throttle valve 23 as necessary. This increase in aperture of the first throttle valve 13 in the first control, and the decrease in aperture of the second throttle valve 23 in the second control are performed at a minimum within a range which can prevent stagnation, i.e. within a range in which the evaporating temperature of the heat transfer medium mA in the outdoor vessel 14 does not exceed the temperature of outside air. Thereby, within this range, the aperture of the first throttle valve 13 is made as small as possible, and the aperture of the second throttle valve 23 is made as large as possible. This is because a smaller aperture of the first throttle valve 13, and a larger aperture of the second throttle valve 23 can more abundantly use the waste heat of the cooling target 79, and thus the energy efficiency of heating further improves.

At the first switching time v1, first, in the state of the second heating mode h2 shown in FIG. 11, the aperture of the first throttle valve 13 is set to a predetermined first threshold or less, and the aperture of the second throttle valve 23 is set to an aperture equal or greater than a predetermined second aperture in advance.

From this state, the aperture of the first throttle valve 13 is gradually increased, and the aperture of the second throttle valve 23 is gradually decreases until becoming zero, while the high-pressure shutoff valve 17 and the low-pressure shutoff valve 43 remain fully opened. Then, when the aperture of the second throttle valve 23 becomes zero, as shown in FIG. 10, the heat transfer medium mA no longer flows to a channel branching to the bypass channel 16 in the middle of the first channel 10, passing through the second channel 20, and then merging together at the fifth channel 50. In other words, the heat transfer medium mA comes to circulate by flowing only in the order of the compressor 61->first channel 10->fourth channel 40->fifth channel 50->compressor 61 again, and switches to the first heating mode h1. Subsequently, the high-pressure shutoff valve 17 is fully closed.

At the second switching time v2, first, from the state of the first heating mode h1 shown in FIG. 10, the high-pressure shutoff valve 17 is fully opened, and then the aperture of the second throttle valve 23 is gradually increased from zero. Thereby, as shown in FIG. 11, the heat transfer medium comes to branch to the bypass channel 16 at the middle of the first channel 10, pass through the second channel 20, and flow also into a channel merging at the fifth channel 50, and switches to the second heating mode h2.

Hereinafter, the configuration and effects of the present embodiment will be summarized.

Also in the present embodiment, the controller 75 performs the stagnation prevention control in the state of the second heating mode h2. Thereby, the period of the second heating mode h2 is lengthened compared to a case of not performing this stagnation prevention control. Based on this, it is possible to improve the energy efficiency of heating of the overall heat pump system 70. Furthermore, it is possible to ensure the durability and reliability of each valve, and lower the frosting frequency.

At the first switching time v1, first, by decreasing the aperture of the second throttle valve 23 until zero, while the high-pressure shutoff valve 17 and the low-pressure shutoff valve 43 are fully opened, it is switched from the second heating mode h2 shown in FIG. 11 to the first heating mode h1 shown in FIG. 10. Based on this, compared to a case assuming to switch from the state of the second heating mode h2 shown in FIG. 11 to the first heating mode h1 by fully closing the high-pressure shutoff valve 17, while setting the aperture of the second throttle valve 23 to an aperture larger than zero, it is possible to gradually decrease the flowrate of the heat transfer medium mA flowing in the second channel 20. Based on this, it is possible to suppress the flow of the heat transfer medium mA from suddenly changing, and thus suppress switching noise, together with suppressing the pressure differential between both sides sandwiching the second throttle valve 23 from sharply declining.

At the second switching time v2, by fully opening the high-pressure shutoff valve 17, and then increasing the second throttle valve 23 from zero, it is switched from the first heating mode h1 shown in FIG. 10 to the second heating mode h2 shown in FIG. 11. Based on this, compared to a case assuming to switch from the first heating mode h1 shown in FIG. 10 to the second heating mode h2 by fully opening the high-pressure shutoff valve 17 from a state of the first heating mode h1 shown in FIG. 1 setting the aperture of the second throttle valve 23 to an aperture larger than zero, it is possible to gradually increase the flowrate of the heat transfer medium mA flowing in the second channel 20. Based on this, it is possible to suppress the flow of the heat transfer medium mA from suddenly changing, and thus suppress switching noise, together with suppressing the pressure differential between both sides sandwiching the second throttle valve 23 from suddenly increasing.

### Other Embodiments

The embodiments shown above can be modified as follows, for example. The heat pump system 70, heating system 80, cooling system 90 and controller 75 may be equipped to a moving body other than the vehicle 100, such as a ship, aircraft or railroad.

It should be noted that in each of the above embodiments, the above method of control by the controller 75 corresponds to the “control method of heat pump system 70”.

### EXPLANATION OF REFERENCE NUMERALS

12 condenser
13 first throttle valve
14 outdoor vessel
17 high-pressure shutoff valve (predetermined shutoff valve)
23 second throttle valve
24 chiller
43 low-pressure shutoff valve (predetermined shutoff valve)
61 compressor
70 heat pump system
75 controller
79 cooling target
80 heating system
90 cooling system
100 vehicle (moving body)
h1 first heating mode
h2 second heating mode
Ia passenger compartment
mA heat transfer medium of heat pump system
mB heat transfer medium of heating system
mC heat transfer medium of cooling system

What is claimed is:

1. A heat pump system that is provided to a moving body, and adapted to switch between a plurality of modes including:
a first heating mode of heating a passenger compartment of the moving body without using waste heat of a predetermined cooling target, and a second heating mode of heating the passenger compartment using the waste heat,
the heat pump system comprising:
a compressor that compresses and feeds a heat transfer medium;
a condenser disposed downstream of the compressor;
a first throttle valve disposed downstream of the condenser, and adapted to regulate an aperture;
an outdoor vessel that is disposed downstream of the first throttle valve, and performs heat exchange between the heat transfer medium and outdoor air;
a second throttle valve that is disposed downstream of at least the condenser, and adapted to regulate an aperture;
a chiller disposed downstream of the second throttle valve, and for cooling the cooling target;
a predetermined shutoff valve adapted to open and close, and adapted to change flow of the heat transfer medium by opening and closing; and
a controller,
wherein the controller:
controls so that the heat transfer medium circulates by passing through the chiller by controlling the aperture of the second throttle valve to an aperture larger than zero during the second heating mode; and
switches, at a first switching time of changing from the second heating mode to the first heating mode, so that the heat transfer medium circulates without passing through the chiller by decreasing the aperture of the second throttle valve until becoming zero, while fully opening the predetermined shutoff valve.

2. The heat pump system according to claim 1, wherein the second throttle valve and the chiller are disposed downstream of the outdoor vessel,
wherein the predetermined shutoff valve is a low-pressure shutoff valve as a valve disposed in a channel branched downstream of the outdoor vessel and upstream of the second throttle valve, and
wherein the controller
fully closes the low-pressure shutoff valve and controls the aperture of the second throttle valve to an aperture larger than zero, during the second heating mode, and
fully opens the low-pressure shutoff valve, and then decreases the aperture of the second throttle valve until becoming zero, at the first switching time.

3. The heat pump system according to claim 1, wherein the predetermined shutoff valve is a high-pressure shutoff valve as a valve disposed in a channel branching downstream of the condenser and upstream of the first throttle valve,
wherein the second throttle valve and the chiller are disposed downstream of the high-pressure shutoff valve, and
wherein the controller
fully opens the high-pressure shutoff valve, and controls the aperture of the second throttle valve to an aperture larger than zero, during the second heating mode, and
decreases the aperture of the second throttle valve until becoming zero, while fully opening the high-pressure shutoff valve, at the first switching time.

4. The heat pump system according to claim 1, wherein the controller increases the aperture of the second throttle valve from zero while fully opening the predetermined shutoff valve, at a second switching time to change from the first heating mode to the second heating mode.

5. The heat pump system according to claim 1, wherein the chiller performs heat exchange between a heat transfer medium of the heat pump system, and a heat transfer medium of a cooling system that cools the cooling target.

6. The heat pump system according to claim 1, wherein the condenser performs heat exchange between the heat transfer medium of the heat pump system, and a heat transfer medium of a heating system that performs heating of the passenger compartment.

7. The heat pump system according to claim 1, wherein a shutoff valve switching sound countermeasure control as control that suppresses output of the compressor and increases the aperture of the first throttle valve in a state of the second heating mode, and then switches to the first heating mode is not executed at the first switching time.

8. The heat pump system according to claim 1, wherein the controller switches to the first heating mode prior to stagnation of the heat transfer medium occurring in the outdoor vessel in the second heating mode, and
performs a predetermined stagnation prevention control in the state of the second heating mode, thereby lengthening a period in which the stagnation does not occur even in the second heating mode, and lengthening a period of the second heating mode, compared to when not performing the stagnation prevention control,
wherein the stagnation prevention control includes at least either one of:
a first control as a control preventing the stagnation by changing the aperture of the first throttle valve; and
a second control as control preventing the stagnation by changing the aperture of the second throttle valve.

9. A heat pump system that is provided to a moving body, and
adapted to switch between a plurality of modes including: a first heating mode of heating a passenger compartment of the moving body without using waste heat of a predetermined cooling target, and a second heating mode of heating the passenger compartment using the waste heat,
the heat pump system comprising:
a compressor that compresses and feeds a heat transfer medium;
a condenser disposed downstream of the compressor;
a first throttle valve disposed downstream of the condenser, and adapted to regulate an aperture;
an outdoor vessel that is disposed downstream of the first throttle valve, and performs heat exchange between the heat transfer medium and outdoor air;
a second throttle valve that is disposed downstream of at least the condenser, and adapted to regulate an aperture;
a chiller disposed downstream of the second throttle valve, and for cooling the cooling target;
a predetermined shutoff valve adapted to open and close, and adapted to change flow of the heat transfer medium by opening and closing; and
a controller,
wherein the controller:
switches to the first heating mode prior to stagnation of the heat transfer medium occurring in the outdoor vessel in the second heating mode, and
performs a predetermined stagnation prevention control in the state of the second heating mode, thereby lengthening a period in which the stagnation does not occur even in the second heating mode, and lengthening a period of the second heating mode, compared to when not performing the stagnation prevention control,
wherein the stagnation prevent control includes at least either one of:
a first control as a control preventing the stagnation by changing the aperture of the first throttle valve; and
a second control as control preventing the stagnation by changing the aperture of the second throttle valve.

10. The heat pump system according to claim 8, wherein the second throttle valve and the chiller are disposed downstream of the outdoor vessel,
wherein the predetermined shutoff valve is a low-pressure shutoff valve as a valve disposed in a channel branching downstream of the outdoor vessel and upstream of the second throttle valve,
wherein the controller fully closes the low-pressure shutoff valve and controls the aperture of the second throttle valve to an aperture larger than zero, during the second heating mode, and
the first control is control for preventing the stagnation by decreasing the aperture of the first throttle valve, and
the second control is control for preventing the stagnation by increasing the aperture of the second throttle valve.

11. The heat pump system according to claim 8, wherein the predetermined shutoff valve is a high-pressure shutoff valve as a valve disposed in a channel branching downstream of the condenser and upstream of the first throttle valve,
wherein the second throttle valve and the chiller are disposed downstream of the high-pressure shutoff valve,
the controller fully opens the high-pressure shutoff valve, and controls the aperture of the second throttle valve to an aperture larger than zero, during the second heating mode,
the first control is control for preventing the stagnation by increasing the aperture of the first throttle valve, and
the second control is control for preventing the stagnation by decreasing the aperture of the second throttle valve.

12. The pump system according to claim 8,
wherein the stagnation prevention control includes both of the first control and the second control.

13. A control method for a heat pump system provided to a moving body, and adapted to switch between a plurality of modes including: a first heating mode of heating a passenger compartment of the moving body without using waste heat of a predetermined cooling target, and a second heating mode of heating the passenger compartment using the waste heat,
the heat pump system including:
a compressor that compresses and feeds a heat transfer medium;
a condenser disposed downstream of the compressor;
a first throttle valve disposed downstream of the condenser, and adapted to regulate an aperture;
an outdoor vessel that is disposed downstream of the first throttle valve, and performs heat exchange between the heat transfer medium and outdoor air;
a second throttle valve that is disposed downstream of at least the condenser, and adapted to regulate an aperture;
a chiller disposed downstream of the second throttle valve, and for cooling the cooling target; and
a predetermined shutoff valve adapted to open and close, and adapted to change flow of the heat transfer medium by opening and closing,
the control method comprising:
controlling so that the heat transfer medium circulates by passing through the chiller, by controlling the aperture of the second throttle valve to an aperture larger than zero, during the second heating mode, and
switching so that the heat transfer medium circulates without passing through the chiller, by decreasing the aperture of the second throttle valve until becoming zero, in a state fully opening the predetermined shutoff valve, at a first switching time at which to change from the second heating mode to the first heating mode.
